(19) United States
(12) Patent Application Publication
(10) Pub. No.: US 2026/0013014 A1
(43) Pub. Date: Jan. 8, 2026

(54) CONDITIONAL MULTl-CHANNEL LIGHTING CONTROL

(71) Applicant: LMPG Inc., Longueuil (CA)

(72) Inventor: Guillaume Boucher, Québec (CA)

(73) Assignee: LMPG Inc., Longueuil (CA)

(21) Appl. No.: 18/932,287

(22) Filed: Oct. 30, 2024

Related U.S. Application Data
(60) Provisional application No. 63/666,962, filed on Jul. 2, 2024.

(51) Int. Cl. H05B 45/20

(52) U.S. Cl. CPC H05B 45/20

(57) ABSTRACT

A lighting control apparatus includes processing circuitry that receives control inputs on multiple input channels and controls a variety of colored lighting elements. The control inputs are processed using a first method to produce a desired lighting output. The processing circuitry determines if control inputs on a specific set of input channels fall within a certain range and, if so, employs an alternate processing method to control the lighting. The alternate method may be selected when the inputs on the predetermined set of channels indicate an unused condition.

### CROSS-REFERENCE TO RELATED APPLICATIONS

This application claims benefit to U.S. Provisional Application No. 63/666,962 filed on Jul. 2, 2024, the contents of which are incorporated by reference herein in their entireties for all purposes.

### FIELD OF TECHNOLOGY

The disclosed system and method is in the field of lighting control and more particularly in the field of multi-channel lighting control of LED lighting systems.

### BACKGROUND

The invention relates to a lighting control apparatus and methods for controlling a lighting apparatus, which includes processing circuitry that receives control inputs on multiple input channels and controls a plurality of colored lighting elements based on these inputs.

Some previously known lighting control systems and methods are able to provide RGBW control and a configurable White CCT within the same fixture. However, in certain control protocols like DMX/RDM, it is not possible to enable both RGBW control and a configurable White CCT at the same time unless more than 4 channels are being used. This means that depending on the configured fixture personality, the device will either be in RGBW mode (i.e., no White correction) or in “Correct White mode” (i.e., no RGBW control because the R, G and B channels are used to correct the white light to the desired CCT). Other protocols like DALI require high-end controllers to enable both RGBW and color temperature control at the same time.

Likewise, without using the present invention, a reconfiguration process would normally be required to reconfigure a fixture from an HSI mode to a CCT/Intensity mode, for example. This could previously have been performed using the DMX/RDM protocol by reconfiguring the fixture on the fly, in which an RDM-compatible controller could send commands to change the personality of a fixture from RGBW to Corrected White. However, requiring the use of an RDM-compatible controller adds significant cost to a product or system and would therefore detrimentally affect sales.

Alternatively, without using the present invention, an additional DMX channel could be provided that would control the mode of operation. However, using more DMX channels per fixture would result in fewer available fixtures in a full DMX universe. For example, a single DMX universe can support up to 170 fixtures of 3 channels each, but only 128 fixtures of 4 channels each and only 102 fixtures of 5 channels each. The DALI protocol does not apply to this use-case since HIS control is not supported by the DALI protocol.

### SUMMARY

In the context of multi-channel light control (e.g., RGBW, HSI, Color Temperature/Intensity), the present invention provides a system and method for supporting many types of control using a standard set of channels, based on conditions on the incoming control signal. The disclosed system and method controls switching operation modes of a color-changing fixture based on conditions on the input control channels to the fixture.

Aspects of the present disclosure include a conditional multi-channel lighting control system and method that provides both RGBW control and White tuning in CCT/Intensity mode using three or fewer channels without reconfiguration. The disclosed multi-channel lighting control system and method also allows both the HSI mode and the CCT/Intensity mode to be available at the same time using the same number of channels without reconfiguration. For example, an HSI control mode and a CCT/Intensity mode are available using only 3 channels without reconfiguration

In an illustrative embodiment, the disclosed lighting control system and method includes an apparatus that may be used to control a plurality of colored lighting elements. The apparatus includes processing circuitry configured to receive control inputs on multiple input channels and to control the lighting elements using a first processing method to provide a selected lighting output. The processing circuitry is further configured to determine if control inputs on a predetermined set of input channels are within a predetermined range, which may be indicative of an unused condition, and to select an alternate processing method for controlling the lighting apparatus in response. The alternate processing method may involve a white mode that automatically shifts a White channel's correlated color temperature (CCT) using predefined ratios when Red, Green, and Blue channels are in a predetermined range or unused. Additionally, the apparatus may activate additional functionalities using the alternate processing method. The methods for controlling the lighting apparatus involve similar steps of receiving control inputs, determining the range of inputs, and selecting the appropriate processing method based on whether the inputs indicate an unused condition.

### BRIEF DESCRIPTION OF THE DRAWINGS

The present invention is described herein in with reference to the following drawings in which like numerals designate like elements and wherein:

FIG. 1 is a process flow diagram showing operations for processing lighting control inputs.

FIG. 1A is a process flow diagram showing selection of an alternative processing method for lighting control.

FIG. 1B is a process control diagram showing maintaining control with the initial method upon specific input conditions.

FIG. 2 is a process flow diagram showing a decision tree for controlling a lighting apparatus according to an illustrative embodiment of the present disclosure.

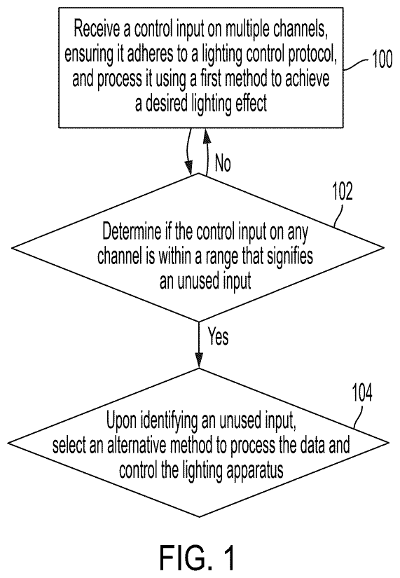

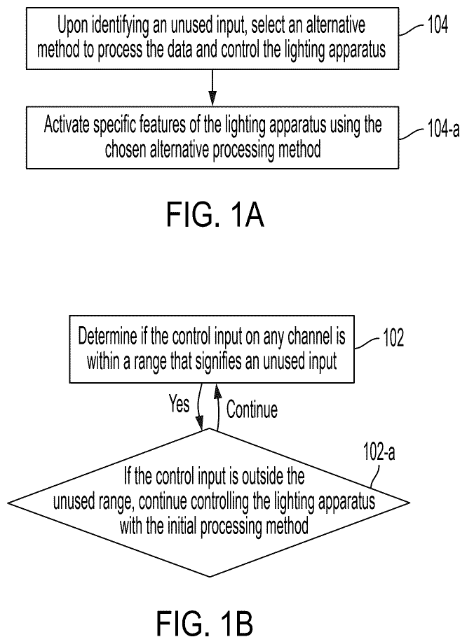

### DETAILED DESCRIPTION

In step 100, the disclosed lighting control process begins with receiving control inputs to a lighting apparatus on multiple channels. The control inputs are formatted in accordance with a lighting control protocol to provide a selected lighting output.

According to an aspect of the present disclosure, processing circuitry is configured for receiving the control inputs and controlling a plurality of colored lighting elements in response to the control inputs. The processing circuitry is a component in a lighting control apparatus, responsible for receiving control inputs on multiple input channels and controlling a plurality of colored lighting elements based on these inputs.

The processing circuitry is configured to receive control inputs formatted in accordance with a lighting control protocol that allows the processing circuitry to interpret the control inputs correctly and provide the desired lighting output.

According to an aspect of the present disclosure, the control inputs are processed using a first processing method to produce a selected lighting output.

The processing circuitry is further configured to determine whether the control inputs on a predetermined set of input channels fall within a predetermined range. This range may correspond to an unused condition on the predetermined set of input channels, for example. If the control inputs are within this range, the processing circuitry selects an alternate processing method, other than the first processing method, to control the lighting apparatus.

In an illustrative embodiment, the alternate processing method may include a White mode where Red, Green, and Blue channels that are in an unused condition, or have inputs within the predetermined range, are used automatically to shift a White channel's correlated color temperature (CCT).

In an illustrative embodiment, the shift in the White channel's CCT is achieved using predefined ratios of the Red, Green, and Blue channels relative to the White channel depend on a color temperature of the White channel and a target corrected color temperature (CCT). In one particular example, the shift in the White channel's CCT is achieved using predefined ratios, which may include a red value of 0%, a green value of 10%, and a blue value of 20% relative to the White channel's value.

In another example, the processing circuitry can activate a functionality in the lighting apparatus using the alternate processing method if the control inputs on the predetermined set of input channels are in the predetermined range.

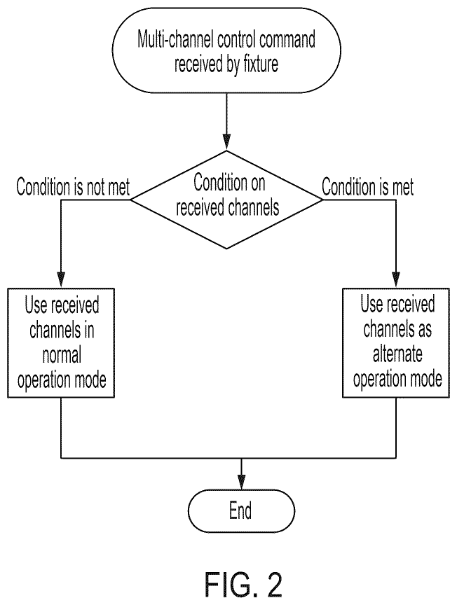

In general, referring to FIG. 2, the processing circuitry is configured to receive and interpret control inputs, determine the appropriate processing method based on the input conditions, and control the lighting apparatus to provide the desired lighting output. The alternate processing method allows for enhanced control and customization of the lighting output based on the specific conditions of the input channels without requiring a reconfiguration or recommissioning of the lighting apparatus.

According to an aspect of the present disclosure, the first processing method may comprise a standard Red Green Blue White (RGBW) lighting control method. This method provides a way to create a wide range of colors and intensities. Alternatively, the first processing method may comprise a standard HSI (Huc/Saturation/Intensity) lighting control method, offering another approach to control the lighting output based on hue, saturation, and intensity parameters.

The alternate processing method may include a white mode where Red, Green, and Blue channels that are in an unused condition are used automatically to shift a White channel's correlated color temperature (CCT). The purpose of the white mode within the alternate processing method is to automatically adjust the White channel's CCT using the unused RGB channels, thereby enhancing the lighting output with predefined ratios to achieve a desired color temperature.

Alternatively, the alternate processing method may include a white mode where a Saturation channel in an unused condition is used to adjust the functionality of a Hue channel, which in turn shifts the White channel's CCT. This feature in the alternate processing method utilizes an unused Saturation channel to modify the Hue channel's functionality, thereby affecting the CCT of the White channel and enhancing the lighting output with more precise color temperature control.

The method may also involve shifting the white point of the lighting output according to the value of the Huc channel, fine-tuning the lighting output's color balance to provide a more customized and potentially more visually appealing lighting effect. In summary, step 102 involves the processing circuitry determining whether the control input on at least one channel is within a predetermined range, indicating an unused input. If so, the circuitry selects an alternate processing method, which may include various modes and adjustments to optimize the lighting output based on the specific conditions of the input channels.

The disclosed dual-method approach to multi-channel lighting control ensures that the lighting apparatus can provide a selected lighting output under various conditions, enhancing the overall functionality and versatility of the lighting system without adding the costs associated with additional channels or high end controllers.

Lighting fixtures with a control protocol that supports control mode changes in its normal mode of operation may be used instead of the presently disclosed system and method, but at substantially greater cost. For example, when using a fixture supporting RGBW and Color Temperature control with a DALI controller supporting both types of commands (RGBWAF and CT), the control only needs to change its control mode and the fixture will work as needed. However, if the controller only supports RGBWAF control, then using the presently disclosed system and method will enable color temperature control by itself, without the need for a CT-compatible controller.

Similarly, if the controller used supports DMX/RDM, then the color temperature control could be enabled by a personality change. This might require more knowledgeable technicians to program the controller so the personality changes occur at the correct moment, for example. However, the disclosed system and method can enable dynamic white features when using standard DMX controllers that do not implement the RDM protocol.

In some implementations of the disclosed system and method, transition from a white LED only mode to a corrected white mode should be performed using a slow transition such that transition from one mode to another appears substantially seamless. Otherwise, using the disclosed system and method in shows or other implementations that make heavy use of RGB channels at low very values, including cases in which RGB channels are completely OFF, the slow CCT might perceptible to a keen eye. Such conditions could make the disclosed system appear to be malfunctioning even though the observed effect is merely an artefact of in inappropriate control condition.

Although DMX and DALI are used as examples herein, persons skilled in the art should appreciate that the disclosed system and method is similarly applicable to other lighting control protocols, depending on their capabilities within the scope of the present disclosure.

1. A lighting control apparatus, comprising:
processing circuitry configured for receiving control inputs on a plurality of input channels and controlling a plurality of colored lighting elements in response to the control inputs;
wherein the control inputs are processed using a first processing method to provide a selected lighting output; and
wherein the processing circuitry is configured to determine whether control inputs on a predetermined set of the input channels are within a predetermined range and to select an alternate processing method for processing the control inputs to control a lighting apparatus in response to determining that the control inputs on the predetermined set of input channels are within the predetermined range.

2. The apparatus of claim 1, wherein the control inputs within the predetermined range on the predetermined set of input channels correspond to an unused condition on the predetermined set of input channels.

3. The apparatus of claim 1, wherein the processing circuitry is configured for determining whether the control input on three channels of the plurality of input channels are within the predetermined range, wherein the predetermined range indicates an unused condition on the three channels; and
wherein the processing circuitry is configured to select the alternate processing method in response to determining that the control inputs on the three channels are within the predetermined range.

4. The apparatus of claim 1, wherein the processing circuitry is configured to receive control inputs formatted in accordance with a lighting control protocol to provide a selected lighting output.

5. The apparatus of claim 1, wherein the processing circuitry is configured to activate a functionality in the lighting apparatus using the alternate processing method.

6. The apparatus of claim 1, wherein the processing circuitry is configured to control the lighting apparatus using the first input processing method in response to determining that the control inputs on the predetermined set of input channels are outside of predetermined range.

7. The apparatus of claim 1, wherein the first processing method comprises a standard Red Green Blue White (RGBW) lighting control method.

8. The apparatus of claim 1, wherein the alternate processing method comprises a white mode wherein Red, Green and Blue channels that are in an unused condition are used automatically to shift a White channel's correlated color temperature (CCT).

9. The apparatus of claim 8, wherein the processing circuitry is configured to shift the White channel's correlated color temperature using predefined ratios.

10. The apparatus of claim 9, wherein the predefined ratios of the Red, Green and Blue channels relative to the White channel depend on a color temperature of the White channel and a target corrected color temperature (CCT).

11. The apparatus of claim 9, wherein the predefined ratios comprise a red value of 0%, a green value of 10% and a blue value of 20% relative to the White channel's value.

12. A method of controlling a lighting apparatus, comprising:
receiving a control input to the lighting apparatus on multiple channels,
wherein the control input is formatted in accordance with a lighting control protocol to provide a selected lighting output and wherein the input data is processed using a first processing method to provide a selected lighting output;
determining whether the control input on at least one channel of the multiple channels is within a predetermined range, wherein the predetermined range indicates an unused input on the at least one channel; and
in response to determining that the control input on the at least one channel is within the predetermined range, selecting an alternate processing method for processing the input data to control the lighting apparatus.

13. The method of claim 12, comprising activating a functionality in the lighting apparatus using the alternate processing method.

14. The method of claim 12, comprising:
in response to determining that the control input on the multiple channels are outside of predetermined range, controlling the lighting apparatus using the first input data processing method.

15. The method of claim 12, wherein the alternative processing method is selected whenever an unused input is detected.

16. The method of claim 12, wherein the alternative processing method provides the selected lighting output based on inputs on the multiple channels.

17. A lighting control method, comprising:
receiving control inputs on a plurality of input channels;
processing the control inputs to activate a plurality of colored lighting elements to provide a selected lighting output in response to the control inputs;
wherein the processing comprises
determining whether control inputs on a predetermined set of the input channels are within a predetermined range corresponding to an unused condition on the predetermined set of input channels;
selecting a first processing method for processing the control inputs to control the lighting apparatus in response to determining that the control inputs on the predetermined set of inputs channels are outside of the predetermined range; and
select an alternate processing method for processing the control inputs to control a lighting apparatus in response to determining that the control inputs on the predetermined set of input channels are within the predetermined range.

18. The method of claim 17, wherein the first processing method comprises a standard Red Green Blue White (RGBW) lighting control method.

19. The method of claim 17, wherein the alternate processing method comprises a white mode wherein Red Green and Blue channels that are in an unused condition are used automatically to shift a White channel's correlated color temperature (CCT).

20. The method of claim 19, wherein the processing circuitry is configured to shift the White channel's correlated color temperature using predefined ratios.

21. The apparatus of claim 20, wherein the predefined ratios of the Red, Green and Blue channels relative to the White channel depend on a color temperature of the White channel and a target corrected color temperature (CCT).

22. The method of claim 20, wherein the predefined ratios comprise a red value of 0%, a green value of 10% and a blue value of 20% relative to the White channel's value.

23. The method of claim 17, wherein the first processing method comprises a standard HSI (Hue/Saturation/Intensity) lighting control method.

24. The method of claim 17, wherein the alternate processing method comprises a white mode wherein, in response to inputs on a Saturation channel being within the predetermined range, the Saturation channel is used to adjust functionality of a Hue channel, wherein the Hue channel value shifts a White channel's correlated color temperature (CCT).

25. The method of claim 24, comprising shifting a white point of the lighting output according to the value of the Hue channel.
